(19) United States
(12) Patent Application Publication
(10) Pub. No.: US 2018/0082372 A1
(43) Pub. Date: Mar. 22, 2018

(54) SYSTEM AND METHOD FOR GENERATING SOLUTIONS USING A RECOMMENDATION ENGINE

(71) Applicant: LeadPoint, Inc., Los Angeles, CA (US)

(72) Inventor: Marc L. Diana, Santa Monica, CA (US)

(21) Appl. No.: 15/710,477

(22) Filed: Sep. 20, 2017

Related U.S. Application Data
(60) Provisional application No. 62/397,662, filed on Sep. 21, 2016.

(51) Int. Cl. G06Q 40/02; G06Q 10/06

(52) U.S. Cl. CPC G06Q 40/025; G06Q 10/0637

(57) ABSTRACT

In one embodiment, a system comprising at least one processor is configured to receive a request comprising an identification of at least two types of debt associated with the client from a client, automatically formulate an electronic query using the information in the request, send the query to at least one situational information provider, receive first information comprising debt data associated with the at least two types of debt associated with the client from the situational information provider, receive second information comprising a plurality of offerings from at least two service providers. The processor is further configured to determine an outcome, for each offering of the plurality of offerings, based on the first information and the second information, select a first offering of the plurality of offerings based on comparing the determined outcomes, and display information about the selected offering to the client.

### RELATED APPLICATION

This application claims the benefit of U.S. Provisional Application 62/397,662, filed Sep. 21, 2016 and entitled “System and Method for Generating Solutions Using a Recommendation Engine,” the contents of which are hereby incorporated by reference in their entirety.

### TECHNICAL FIELD

This disclosure relates generally to electronically generating solutions, and more specifically to systems and methods for generating solutions using a recommendation engine.

### BACKGROUND

Generally, resolving an issue involves gathering information about potential solutions and selecting one of the potential solutions to resolve the issue. In typical systems, the information gathering and the selection is completed by a solution seeker. That is, the solution seeker compiles information regarding possible solutions and chooses a solution from the information gathered. In deciding which solution to choose, the solution seeker generally bases his/her decision on information he/she knows about the issue. However, basing a decision on this type of first party information can be inaccurate and/or unreliable. For example, information about the issue may have changed since the solution seeker last (if ever) verified the information. As another example, the solution seeker may not be knowledgeable about any/all information that may affect the selection of a solution. As a result, solutions generated using first party information may not be optimal solutions for the particular issue experienced by the solution seeker.

### SUMMARY

In one embodiment, a system comprising at least one processor is configured to receive a request from a client over the Internet and automatically formulate an electronic query using the information in the request. In some embodiments, the requested information comprises an identification of debt associated with the client. The processor is also configured to send the query over the Internet to at least one situational information provider, receive first information over the Internet from the situational information provider and receive second information over the Internet from service providers. In some embodiments, the first information comprises debt data associated with the debt associated with the client and the second information comprises a plurality of offerings. The processor is further configured to determine an outcome, for each offering of the plurality of offerings, based on the first information and the second information, select a first offering of the plurality of offerings based on comparing the determined outcomes, and display information about the selected offering to the client.

The present disclosure provides, in various embodiments, solutions to technological problems that exist in making a decision. For example, advantages present in various embodiments of the present disclosure include providing clients with the ability to understand their debt by category (e.g., credit card, mortgage, personal, automobile, and/or student-related) and to optimize their debt across and within each category. Other advantages include tailoring solutions to the potential client, finding the best available solutions for the potential client, relieving anxieties related to decision-making, improving potential client's confidence in making a decision, decreasing the incidence of “buyer's remorse,” and enabling greater client satisfaction. Other objects, features, and advantages of the present disclosure are apparent to persons of ordinary skill in the art in view of the following detailed description of the disclosure and the accompanying drawings.

### BRIEF DESCRIPTION OF THE DRAWINGS

For a more complete understanding of the configurations of the present disclosure, needs satisfied thereby, and the objects, features, and advantages thereof, reference now is made to the following description taken in connection with the accompanying drawings.

FIG. 1 is a schematic illustrating an example of a network environment for a recommendation engine for generating solutions.

FIG. 2 is a schematic illustrating the recommendation engine of FIG. 1, according to a particular embodiment.

FIG. 3 is a flow chart illustrating a method for generating solutions using the recommendation engine of FIG. 2, according to one embodiment.

FIGS. 4-6 illustrate examples of interfaces displaying solutions provided by the recommendation engine of FIG. 2, according to particular embodiments.

FIG. 7 is a block diagram illustrating an example of a computer system that can be used to implement the recommendation engine of FIG. 2, according to one embodiment.

FIGS. 8A-8B illustrate an example of a signal flow in the network environment, according to particular embodiments.

### DETAILED DESCRIPTION

At any given time, a large number of potential customers, clients, or other consumers may be seeking a solution to an issue that they are currently experiencing where the solution involves choosing amongst multiple third party offerings and analyzing data about the problem from another third party. For example, a potential client may be seeking a solution to optimize his or her debt. The potential client may have one or more of the following debts: mortgage, student loan, personal loan, automobile loan, and credit cards. One possible solution may be to refinance a first debt with a new lender offering a lower interest rate than the rate that the client pays on the existing debt. Another possible solution may be to acquire new debt and transfer the existing debt into new debt. Other possible solutions include paying off the existing debt and/or negotiating the existing debt down. In addition to gathering information about the possible solutions available to the potential client, the potential client must know and provide information about his/her existing debts and/or self in order to make an informed and responsible decision to modify existing debts. For example, in determining whether to refinance a mortgage, the potential client may need to provide first party information including current mortgage balance, annual interest rate, number of months remaining on the mortgage, origination year of the mortgage, current value of potential client's home, and current credit score. The potential client may or may not know any/all of this first party information and may supply inaccurate or unreliable information that ultimately affects his/her decision to refinance.

As another example, a potential client may be running low on available disk space on his or her client device and may be seeking a solution to resolve this issue. One possible solution may be to free up space on the existing drive. Another possible solution may be to acquire additional storage space. Each of these possible solutions may be associated with a large number of products or services made available by various manufacturers, service providers, or vendors. For example, if the potential client decides to acquire additional storage space, he may also need to decide whether to acquire a physical drive (e.g., external hard drive) or a cloud drive (e.g., virtual drive such as those offered by Google, Dropbox, or Amazon). In addition to the potential client's needs, other considerations might also affect the potential client's decision to purchase a product or service. For example, the cost of product/service, the capacity of the product/service, the ease of use of the product/service, and customer rating of the product/service are all factors that may influence a potential customer's decision to acquire a particular product/service. Additionally, various situational factors associated with the client may need to be accounted for. As an example, situational factors related to the present example may include compatibility of the product/service with the client device and continuous accessibility of the product/service on the client device. In some instances, the client may not be knowledgeable or aware of various situational factors associated with the client device, and as a result, the client may select a solution that he/she is ultimately unhappy with.

The above examples illustrate the complexity of decision-making. It can be appreciated that a seemingly simple decision (e.g., deciding to refinance or deciding upon a storage solution) can become increasingly difficult when presented with a number of solutions and when the problem is multifaceted. While those seeking a solution have turned to computer technology for assistance, existing computer technology has failed to provide adequate solutions to certain problems such as the ones described above. One objective of some embodiments of the present invention is to generate solutions using a recommendation engine that improves the state of present computing technology. A recommendation engine, such as described herein, may provide various benefits to the potential client, including but not limited to, tailoring solutions to the potential client, finding the best available solutions for the potential client, relieving anxieties related to decision-making, improving potential client's confidence in making a decision, decreasing the incidence of “buyer's remorse,” and enabling client satisfaction. The techniques discussed herein result in these benefits by improving the ability of computer technology to address multifaceted problems in which multiple offerings from third party providers are analyzed to determine a solution.

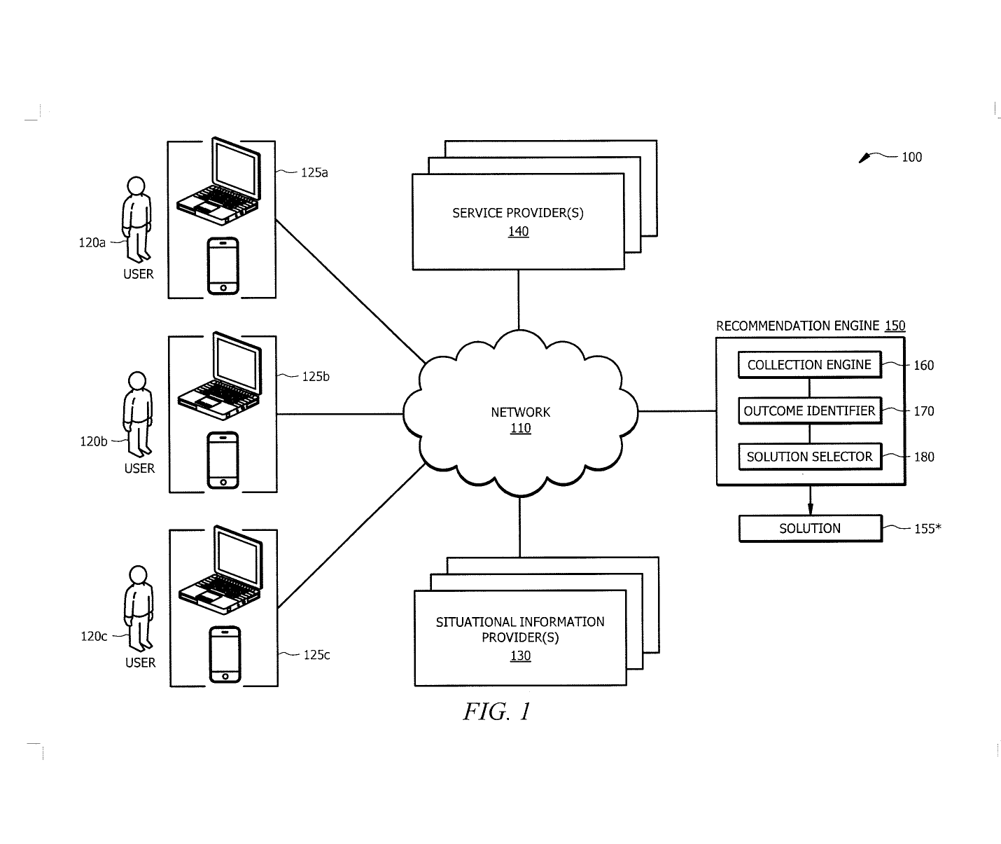

FIG. 1 illustrates an example of a network environment 100 for a recommendation engine 150 for generating solutions. The network environment may include a network 110, one or more users 120, one or more client devices 125, one or more situational information providers 130, one or more service providers 140, and a recommendation engine 150 that are each communicably coupled to one another.

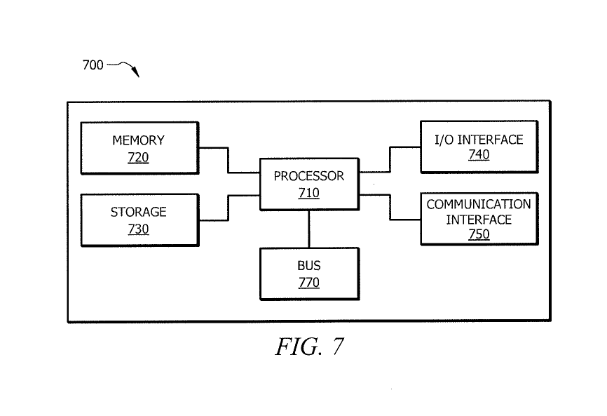

In general, the teachings of this disclosure recognize using a recommendation engine to recommend one or more solutions to a user based on situational information associated with the user and information about a plurality of solutions. Recommendation engine 150 may receive the situational information and the information about the available solutions over network 110 from users 120, situational information providers 130, and/or service providers 140. Executing recommendation engine 150 on a computer system, such as computer system 700 of FIG. 7, prompts the generation of one or more solutions. In some embodiments, the generated solution represents the best available solution for the user based on the plurality of solutions available and the situational information associated with the user. For example, in one embodiment, recommendation engine 150 receives situational information 210 (e.g., information about user 120's debt) about user 120 from situational information providers 130 and information about a plurality of solutions 155 (e.g., debt optimization offerings) from service providers 140 (e.g., lenders, credit card companies, and/or debt settlement companies). Recommendation engine 150 determines an outcome 230 (e.g., savings to user 120) for each solution of the plurality of solutions 155 based on the situational information and the plurality of solutions 155, selects one or more of the solutions of the plurality of solutions 155 based on determined outcomes 130, and displays information about the one or more selected debt optimization offerings 155* to user 120. In some embodiments, user 120 may select one or more of the displayed offerings 155* and optimize his/her debt accordingly.

Network 110 may refer to any interconnecting system capable of transmitting audio, video, signals, data, messages, or any combination of the preceding. Network 110 may include all or a portion of a public switched telephone network, a public or private data network, a local area network (LAN), an ad hoc network, a personal area network (PAN), a metropolitan area network (MAN), a wide area network (WAN), a local, regional, or global communication or computer network such as the Internet, an enterprise intranet, or any other suitable communication link, including combinations thereof. One or more portions of one or more of these networks may be wired or wireless. Examples of wireless networks 110 may include a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these.

The network environment 100 may include one or more users 120. As depicted in FIG. 1, network environment 100 includes three users 120a-c. Although this disclosure depicts and describes a particular number of users 120, this disclosure recognizes that network environment 100 may include any suitable number of users 120. In some embodiments, users 120 are users of recommendation engine 150. For example, user 120a may use recommendation engine 150 to determine one or more solutions 155* for a financial issue (e.g., the debt optimization issue described above). As another example, user 120b may use recommendation engine 150 to determine one or more solutions 155* to resolve a storage issue (e.g., the storage issue described above). As yet another example, user 120c may use recommendation engine 150 to identify a domain registrar to host a website of user 120c, wherein the website of user 120c includes particular functionality that is no longer supported by his current domain registrar. This disclosure recognizes that users 120 may use recommendation engine 150 to generate solutions for a wide variety or problems or issues experienced by users 120.

Users 120 may use one or more client devices 125 to communicate over network 110. As depicted, network environment 100 includes three sets of client devices 125a-c, wherein each set is associated with a user 120. Client device 125 may be an electronic device including hardware, software, or embedded logic components or a combination of two or more such components and capable of carrying out the appropriate functionalities implemented or supported by client device 125. As an example and not by way of limitation, a client device 125 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client device 125.

Client device 125 may be communicatively coupled to one or more components of network 110 (e.g., situational information provider 130, service provider 140, recommendation engine 150). In some embodiments, client device 125 may interface with recommendation engine 150 through a dedicated application offered in an application store (e.g., Google Play store, Apple App Store, Mac App Store). In some embodiments, client device 125 may include a web browser, such as MICROSOFT INTERNET EXPLORER, GOOGLE CHROME, or MOZILLA FIREFOX, and may have one or more add-ons, plug-ins, or other extensions. Client device 125 may also be configured to interface with recommendation engine 150 through a browser. A user of client device 125 (e.g., user 120) may enter a Uniform Resource Locator (URL) or other address directing the web browser to a particular server, and the web browser may generate a Hyper Text Transfer Protocol (HTTP) request and communicate the HTTP request to HTTP server 120. The server may accept the HTTP request and communicate to client device 125 one or more files responsive to the HTTP request. The responsive files may include one or more Hyper Text Markup Lanuage (HTML) files, EXtensible Markup Language (XML) files, JavaScript Object Notation (JSON) files, Cascading Style Sheets (CSS) files, pictures, other files, or any other suitable data that is transferable over HTTP. Client device 125 may render a webpage based on the responsive files from the server for presentation to a user.

In some embodiments, network environment 100 may also include one or more situational information providers 130. As used herein, a situational information provider may provide information associated with user 120 (also referred to herein as “situational information”) to recommendation engine 150. In some embodiments, situational information provider 130 collects situational information about user 120 over time (e.g., U.S. Census Bureau). In other embodiments, situational information provider 130 collects situational information about user 120 for a specific time (e.g., information as of “X” date). A situational information provider 130 may be a manufacturer of a product owned by user 120 and/or a service provider of a service rendered to user 120. In some embodiments, situational information provider 130 may be a company that maintains records about users 120 (e.g., credit reporting agency). In other embodiments, situational information provider 130 may be a financial institution or entity that user 120 is associated with (e.g., user 120 maintains an account with the financial institution). In yet other embodiments, situational information provider 130 may be user 120 himself or herself. Although specific examples of situational information providers 130 have been described, this disclosure recognizes that a situational information provider includes any person or entity that may relay information associated with user 120 to recommendation engine 150.

Network environment 100 may also include one or more service providers 140. Service providers 140 may be any person or entity offering a solution. As used herein, a solution may be a product, a service, or any other suitable offering of the service provider 140. For example, in some embodiments, service provider 140 may be a lender offering a loan and/or mortgage (e.g., Wells Fargo, Toyota Motor Finance, Discover Bank). As another example, in some embodiments, service provider 140 may be a credit card company offering a credit card (e.g., American Express, Chase, Citibank). As yet another example, service provider 140 may be a financial institution offering checking and/or savings accounts (e.g., banks, credit unions). In yet other embodiments, service provider 140 may be a credit score and/or credit history provider (e.g., Experian, Equifax). Service providers 140 may also be manufacturers offering products and/or service providers offering services to user 120.

Network environment 100 may also include recommendation engine 150. Recommendation engine 150 is a data processing program that generates solutions according to embodiments of the present disclosure. Recommendation engine 150 may be a computer-executable file, such that it may be stored on and executed by a computer (e.g. computer 700 of FIG. 7). In some embodiments, such as depicted in FIG. 1, recommendation engine 150 comprises a collection engine 160, an outcome identifier 170, and a solution selector 180. In general, recommendation engine 150 is configured to receive information about the plurality of solutions and situational information, determine an outcome for each solution of the plurality of solutions based on the situational information and the information about the plurality of solutions, and recommend a solution of the plurality of solutions to the client.

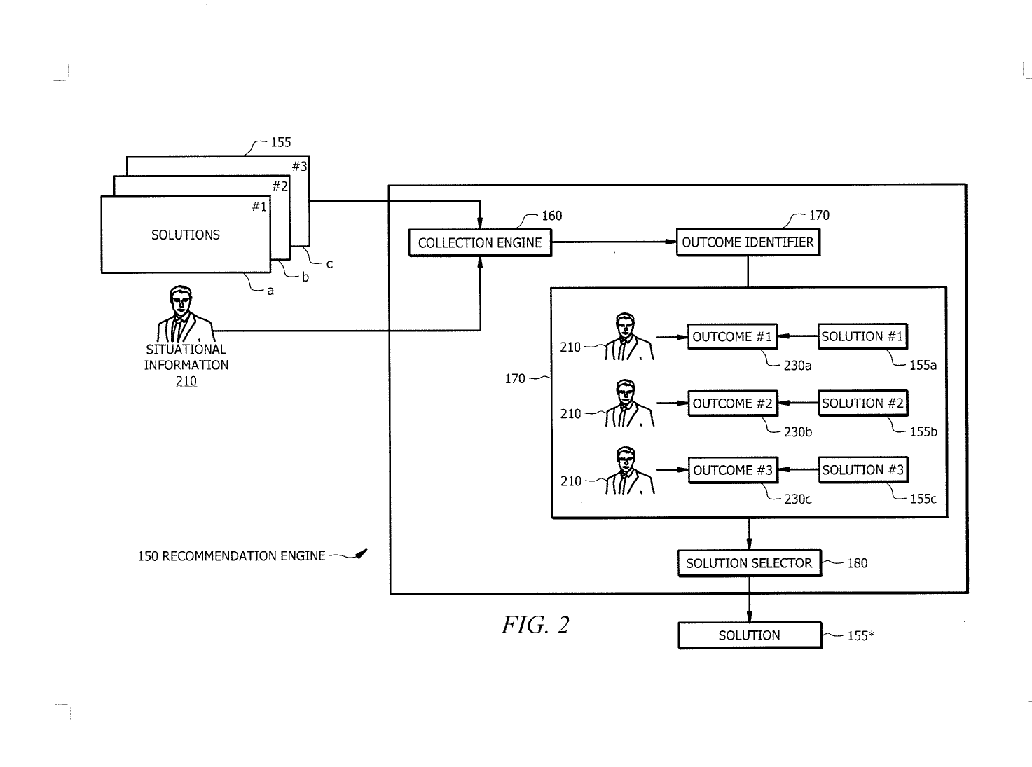

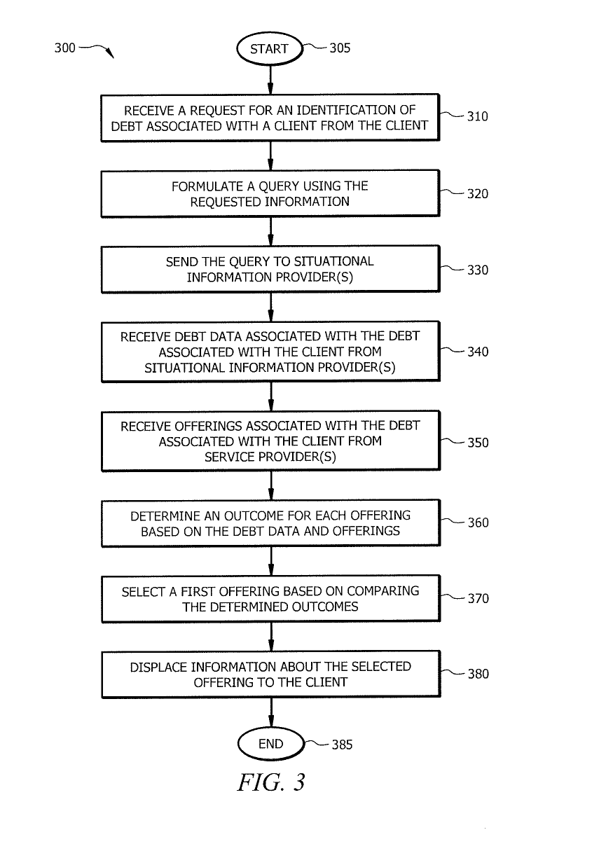

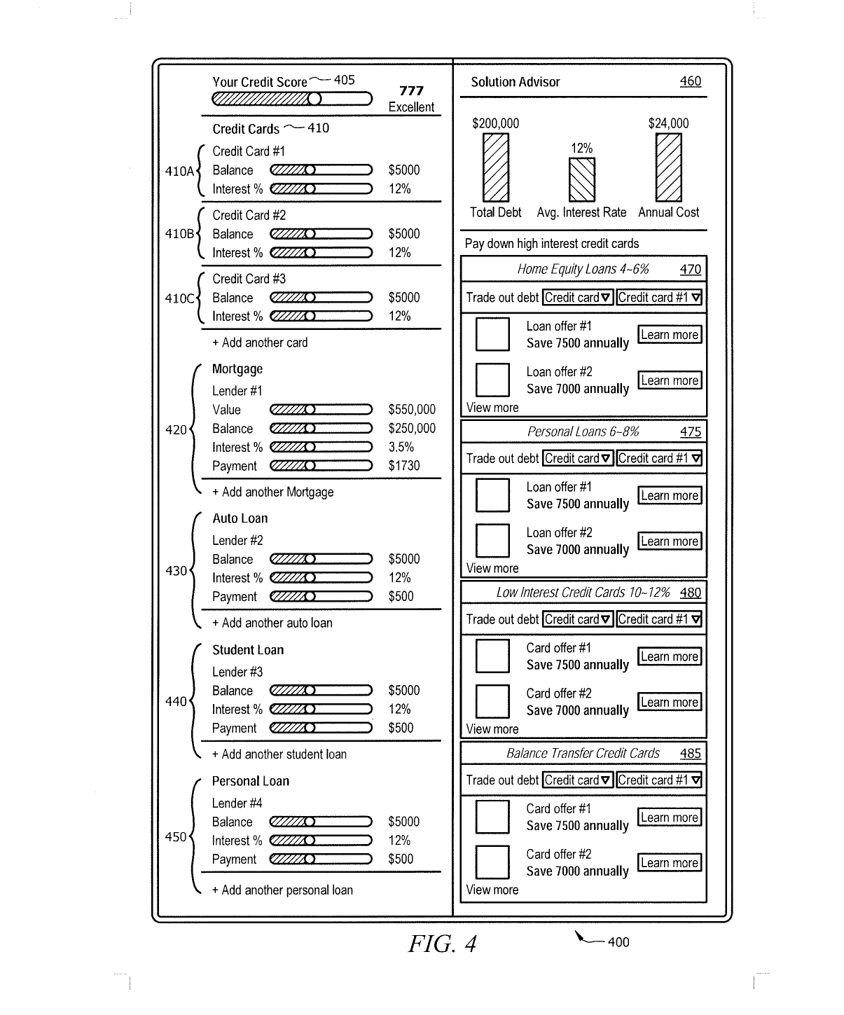

Recommendation engine 150 is described in more detail below in reference to FIG. 2. In some embodiments, recommendation engine 150 generates solutions according to a method 300 described below in reference to FIG. 3. FIGS. 4-6 illustrate different interfaces displayed to a client upon execution of recommendation engine 150. Finally, a computer system, such as a device configured to run recommendation engine 150, is illustrated and described in reference to FIG. 7.

FIG. 2 is a schematic illustrating recommendation engine 150 according to at least one embodiment. As mentioned above in reference to FIG. 1, recommendation engine 150 may comprise a collection engine 160, an outcome identifier 170, and a solution selector 180. In some embodiments, modules 160, 170, and 180 are executable software. In other embodiments, engines 160, 170, and 180 are hardware. In yet other embodiments, engines 160, 170, and 180 are a combination of software and hardware. Recommendation engine 150 is configured to receive information over network 110 in some embodiments. For example, recommendation engine 150 may be configured to receive situational information 210 and information about a plurality of solutions 155 from users 120, situational information providers 130, and service providers 140.

Collection engine 160 may be configured to receive situational information 210 and information about a plurality of solutions 155. As depicted in FIG. 2, collection engine 160 receives information about solutions #1-3 (155a-c) and situational information 210. As described above, situational information 210 may comprise information associated with user 120. In some embodiments, collection engine 160 receives situational information from user 120. In other embodiments, collection engine 160 receives situational information 210 from one or more third party situational information providers 130. In yet other embodiments, collection engine 160 receives situational information 210 from both user 120 and one or more third party situational information providers 130.

In some embodiments, collection engine 160 may receive information from a file transfer protocol. In other embodiments, collection engine may receive information from a fillable form configured to be completed by user 120 and/or situational information provider 130. In yet other embodiments, collection engine 160 may receive information from an application program interface (API). The API may be configured to organize, store, and update the received information. The API may provide recommendation engine 150 access to situational information 210 made available by one or more situational information providers 130. Using an API may provide various benefits. For example, an API may permit simultaneous updating of situational information 210. The API may be linked to any number of situational information providers 130. Additionally, the API may be configured to receive information about a plurality of solutions made available by any number of service providers 140. The plurality of solutions 155 may be any number of solutions identified to resolve the issue identified by user 120. In some embodiments, recommendation engine 150 may encrypt the received information. In some other embodiments, recommendation engine 150 may require secure login to access recommendation engine 150 and the received information (e.g., plurality of solutions 155 and situational information 210).

In some embodiments, the information received by collection engine 160 may not be in human readable format. As such, recommendation engine 150 may be configured to translate the information into human readable format. In some embodiments, recommendation engine 150 may identify information received in machine readable format and translate the received information into human readable format. For example, recommendation engine 150 may translate “CHASE HOME MTG” into “Chase Home Mortgage.” As another example, recommendation engine 150 may translate “CITIBANK USA NA-SEARS” into “CitiBank Sears Mastercard.” This disclosure recognizes that recommendation engine 150 may translate information at any suitable point. For example, recommendation engine 150 may translate information upon receipt of information in machine readable format (e.g., when received by collection engine 160). As another example, recommendation engine 150 may translate information upon a determination that the machine readable format information is required (e.g., before outcome identifier 170 generates one or more outcomes 230).

Collection engine 160 may receive any type of suitable situational information 210 about user 120. For example, collection engine 160 may receive a credit report including the name of all service providers 140 that user 120 is associated with. Collection engine 160 may also receive situational information 210 about all types of debts associated with user 120 (e.g., mortgage debt, credit card debt, personal load debt, student-related debt, automobile-related debt) and information about each debt (e.g., term of each debt, interest rate of each debt, balance for each debt, minimum monthly payment for each debt, remaining payoff period for each debt, information regarding the state and/or country that issued the debt). In some embodiments, such as when the API does not provide certain situational information 210, recommendation engine 150 may require user 120 to provide additional information before a solution may be generated. In such embodiments, recommendation engine 150 may save the additional information entered by user 120.

Recommendation engine 150 may receive information periodically or all at once. For example, recommendation engine may receive information about the plurality of solutions 155 from service providers 140 as solutions are generated by service provider 140. As another example, recommendation engine 150 may receive solutions from service providers 140 upon request. Although specific frequencies of receiving information have been described, this disclosure recognizes receiving situational information 210 and/or information about the plurality of solutions 155 at any suitable frequency. Further, this disclosure recognizes that situational information 210 and information about the plurality of solutions 155 may be received at the same or different frequency. In some embodiments, recommendation engine 150 receives situational information 210 upon a client request to generate a solution 155.

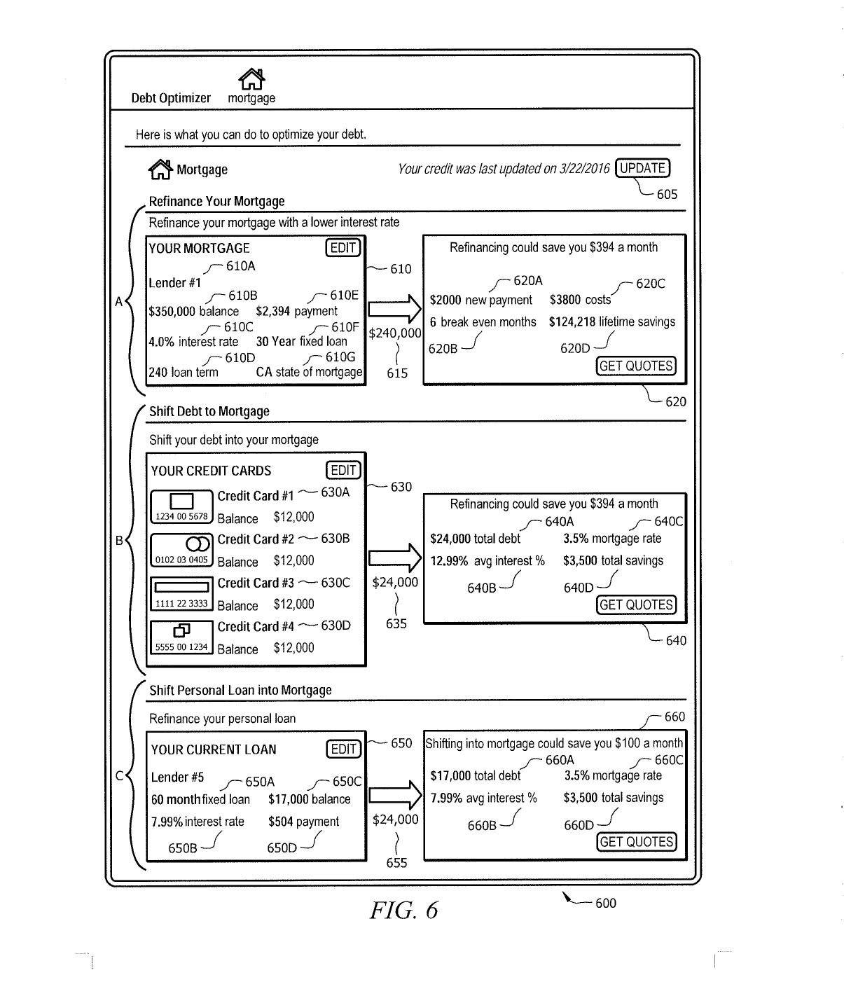

In some embodiments, recommendation engine 150 may be configured to update the received information (e.g., plurality of solutions 155 and situational information 210). For example, in some embodiments, received information may be updated automatically before recommendation engine 150 generates solution 155* for user 120. In other embodiments, user 120 may cause received information to be updated (e.g., see interaction button 605 in FIG. 6). Although this disclosure describes particular ways and/or timing of updating received information, this disclosure recognizes that the received information may be updated at any suitable time.

In some embodiments, updating the information comprises deleting or replacing information. For example, in some embodiments, received information that is no longer available or applicable may be deleted (e.g., deleting information relating to a solution that is no longer being offered by service provider 140 and/or deleting information relating to a credit card of user 120 that has been canceled since the last update). As another example, in some embodiments, received information that is outdated may be replaced (e.g., replacing address of user 120 and/or replacing cost of product reflecting a price increase/decrease). In some other embodiments, updating the received information comprises adding new information that was not available at the time of the last update (e.g., adding information relating to a new service offering of service provider 140 and/or adding balance information of a credit card of user 120).

In some embodiments, recommendation engine 150 may save all received information. As mentioned above, the received information may be received directly from user 120 or from service providers 140. For example, the received information may be data input by user 120 during the sign-up process, information input by user 120 into various web forms (e.g., profile information, financial information), information from service providers 140 collected from lead capture forms, and information from service providers 140 that have access to credit reporting information about users 120. Although various sources of information have been described, this disclosure recognizes that recommendation engine 150 may save/store information provided from any source.

In some embodiments, recommendation engine 150 may be configured to save received information to an internal or external storage drive (e.g., memory 702 or storage 706 of FIG. 7). The saved information may be stored in a relational database in some embodiments. In other embodiments, the saved information may be stored in a searchable index. The saved information may include user profile data in some embodiments. User profile data may include data about one or more users 120, including: first name, last name, email address, mailing address (including street, unit or apartment number, city, state, region, country, and zip code data), geographical coordinates (including latitude and longitudinal information), a telephone number (including country code, area code, domestic number, and extension if applicable), a facsimile number (including country code, area code, and domestic number if applicable), and personal website information (e.g., Facebook®, Twitter®, and/or LinkedIn® uniform resource locator (URL) information). User profile data may also include a designated marketing area in some embodiments. The designated marketing area may comprise a region or area where particular solutions 155 are offered. In some embodiments, user profile data may also include an image such as a photo, picture, avatar, or any other suitable image or logo. The image may be resized or reformatted and different versions of the image may be saved (e.g., original, cropped, and/or thumbnail). For example, the logo may represent a finance professional assigned to user 120 by recommendation engine 150. As another example, the logo may represent user 120. In some other embodiments, user profile data may include a description and/or short description about user 120. Such descriptions may be automatically generated or may be input by user 120.

The saved information may also include user credit data in some embodiments. Each user 120 may be associated with zero or more sets of credit data. Each set of credit data may include one or more of a unique identifier, a loan type (e.g., mortgage, credit card, personal loan automobile loan, student-related loans), a loan subtype (e.g., fixed, variable, length of loan), a loan start date, current value of the loan, operating region of the loan (e.g., state that offered the loan), and/or interest rate associated with the loan.

The saved information may also include offer (also referred to as “solution”) data in some embodiments. Various aspects about offers may be save/stored. For example, for each offer, recommendation engine 150 may store/save information about: loan type (e.g., mortgage, credit card, personal loan, automobile loan, student-related loans), loan subtype (e.g., fixed, variable, length of loan), an associated marketing image (e.g., credit card image for credit cards, bank logo for mortgages), a credit score minimum, a credit score maximum, an interest rate, APR, introductory interest rate, duration of the introductory interest rate, maximum balance, state and/or region, payoff duration and/or a hyperlink or URL to the offer.

In some embodiments, recommendation engine 150 comprises outcome identifier 170. Outcome identifier 170 is configured to determine outcomes 230 based on the received information (e.g., plurality of solutions 155 and situational information 210). In some embodiments, outcome identifier 170 may identify an outcome 230 for each solution of the plurality of received solutions 155 based on the received information (e.g., situational information 210 and information associated with the plurality of solutions 155). An outcome 230 as used herein refers to a basis to choose a particular solution over another. For example, an outcome may be a ranking of one solution relative to another. An outcome may also be a cost associated with a product or service or a computation such as the total savings associated with a particular solution. An outcome may also be a categorization (e.g., identifying whether a particular solution is a good solution based on situational information). Categorizing a solution may be based on a threshold analysis. Although specific examples of outcomes are described, this disclosure recognizes that an outcome may be any suitable information that identifies a reason to choose a particular solution.

Outcome identifier 170 may use all or a portion of the information received by collection engine 160 to determine outcomes 230. For example, in response to user 120's selection to optimize her mortgage debt, outcome identifier 170 may ignore information related to situational information 210 that does not result in mortgage debt optimization (e.g., information related to student and/or automobile-related debt). As another example, in response to user 120's selection to optimize her mortgage debt, outcome identifier 170 may ignore information about a plurality of solutions 155 that do not result in mortgage debt optimization for user 120. Thus, in some embodiments, outcome identifier 170 may be configured to filter through information received by collection engine 160. In some embodiments, filtering information received by collection engine 160 comprises selecting a debt type (e.g., mortgage debt, credit card debt, personal loan debt, student-related debt, automobile-related debt). In some embodiments, if not already in human readable format, recommendation engine 150 translates the selected information into human readable format. In some embodiments, if recommendation engine 150 is unable to translate any of the received information into human readable format, recommendation engine 150 flags the information for manual review. In some embodiments, recommendation engine 150 translates information in machine readable format into human readable format based on a listing of translations. In some embodiments, the listing of translations may be stored on a local drive or an external drive. The listing of translations may be configured to be manually added to or edited.

As mentioned above, outcome identifier 170 may use a calculation or computation to identify an outcome 230. In some embodiments, outcome identifier 170 may supplement received information (situational information 210 and/or information associated with the plurality of solutions 155). For example, if situational information 210 includes information that user 120 has credit card debt but does not include the interest rate associated with the credit card debt, outcome identifier 170 may provide an interest rate for the user 120's credit card debt to determine one or more outcomes 130. In some embodiments, outcome identifier 170 supplements variables (such as interest rates) based on calculations. In other embodiments, outcome identifier 170 supplements variables based on rules. For example, outcome identifier 170 may be configured to follow a rule such as: set interest rate to 14% for all cases when the debt type is determined to be credit card debt. Outcome identifier 170 may also be configured to follow more complex rules such as: “if the debt type in a case is determined to be credit card debt, and the service provider 140 of the credit card debt is determined to be BANK OF AMERICA, and the credit card debt is associated with a minimum payment amount of $20, then determine that the interest rate is (1−((balance/minimum payment amount)/100)); else, if the debt type in a case is determined to be credit card debt, and the service provider 140 of the credit card debt is determined to be BANK OF AMERICA, then determine that the interest rate is 13%; else . . . ” In some embodiments, the rules and/or calculations used to supplement received information is stored internally or externally. In some embodiments, rules and/or calculations used to supplement received information may be added to or updated.

Outcome identifier 170 is configured to determine at least one outcome 230 for each solution of the plurality of solutions 155, based on the received information, in some embodiments. As depicted in FIG. 2, outcome identifier 170 determines outcomes 230a-c, wherein outcome 230a is determined based on situational information 210 and information associated with solution 155a, outcome 230b is determined based on situational information 210 and information associated with solution 155b, and outcome 230c is determined based on situational information 210 and information associated with solution 155c. In some embodiments, outcome identifier 170 determines outcomes 230 for each user debt 120 separately. In some other embodiments, outcome identifier 170 determines outcomes 230 for each type of user debt. In such embodiments, outcome identifier 170 may base outcomes 230 on an actual or estimated calculations of aggregate debt and associated rates.

Recommendation engine 150 may be configured to optimize debts in a variety of situations. For example, recommendation engine 150 may be used to optimize a single debt of user 120, a type of debt of user 120 (e.g., mortgage, credit card, personal, automobile, student-related), and/or all debts of user 120. In each scenario, recommendation engine 150 may recommend one or more solutions 155. A recommended solution 155 may comprise one or more offers of one or more service provider 140. For example, a first user 120 has $100,000 in student debt with an interest rate of 7.8% over 10 years and is presented with Solution 1 comprising Offer #1 from Service Provider #1 (refinance $75,000.00 at 4.5% over 10 years) and Offer #2 from Service Provider #2 (refinance $25,000 at 5% over 10 years). As another example, the same user 120 may be presented with Solution 2 from Service Provider #3 comprising Offer 1 (refinance $95,000 at 4.8% over 10 years). As yet another example, the same user 120 may be presented with Solution 3 comprising Offer 1 from Service Provider #1 (refinance $100,000 at 5.2% over 10 years).

Outcome identifier 170 may base an outcome 230 on situational information 210 and information about multiple solutions 155 in some embodiments, such as those circumstances when user 120 seeks to optimize a type of user debt (e.g., all credit card debt) rather than a specific debt (e.g., a single credit card debt). For example, outcome identifier 170 may perform multiple calculations or computations to determine a single outcome 130 (e.g., overall savings when all credit card debt is optimized). For example, user 120 may seek to optimize her aggregate credit card debt having a total balance of $15,000 and an average interest rate of 18%. Outcome identifier 170 may bundle one or more solutions 155 (e.g., offering a home equity loan of $10,000 and offering a balance transfer of $5,000 at a 15% interest rate) and determine an outcome 130 based on the bundle of solutions 155 (e.g., lifetime savings based on the identified solutions). As another example, if user 120 has three credit cards carrying balances of $9,000, $7,500, and $2,000, and user 120 is eligible for a solution offering a $15,000 home equity loan, outcome identifier 170 may determine that to pay off the credit card carrying the $9,000 balance and to pay down the credit card carrying a $7,500 balance if that solution provides user 120 with the most savings.

As mentioned above, outcome identifier 170 may perform one or more calculations when determining outcomes 230. In some embodiments, outcome identifier 170 determines outcome 230 by performing a calculations such as: total payoff amount for an existing (e.g., all debts, type of debt, specific debt) user 120 debt; monthly payments for an existing user 120 debt; total payoff amount for existing user 120 debt based on a solution 155; monthly payments for existing user 120 debt based on a solution 155. In other embodiments, such calculations may be used to calculate more complex calculations such as total savings ([total payoff amount for user 120 debt]−[total payoff amount for user 120 debt based on solution 155]) and/or monthly payment savings ([monthly payments for existing user 120 debt]−[monthly payments for existing user 120 debt based on solution 155]). To make these calculations, variables such as balance of existing debt of user 120 (e.g., all debts of user 120, type of debt of user 120, and/or a specific debt of user 120), balance associated with solution 155, payoff term of existing debt of user 120, payoff term associated with solution 155, interest rate of existing debt of user 120, and interest rate associated with solution 155, may be needed by outcome identifier 170. As described above, recommendation engine 150 (or any particular engine thereof, such as outcome identifier 170) may supplement received information (situational information 210 and/or information about the plurality of solutions 155) to perform any suitable calculations.

In some embodiments, outcome identifier 170 extracts variables from situational information 210. In other embodiments, outcome identifier 170 may use one or more formulas to identify variables useful to determining outcomes 230. For example, outcome identifier 170 may use the following formula to determine a monthly payment (c) associated with a user 120's mortgage, when the monthly interest rate (r), the number of monthly payments (N), and principal (amount borrowed) (P) are known:

c=(rP)/(1−(1+r)^{-N}

Outcome identifier 170 may derive total payoff amount for mortgage of user 120 based on a calculated monthly payment (or alternatively, a monthly payment received from situational information 210). For example, in one embodiment, outcome identifier 170 calculates a total payoff amount associated with a user 120's mortgage by using the following formula:

payoff=((mortgage duration in months)−(months since mortgage start))*monthly payment

In some embodiments, formulas are saved internally or externally. In some embodiments, the saved formulas may be manually added to or edited.

Outcome identifier 170 may use calculated or extracted variables to determine outcomes 230 based on solutions 155. For example, a first mortgage solution 155 may include a mortgage duration and an interest rate. Combining these known variables with the user's current mortgage balance will provide outcome identifier 170 with the information it needs to calculate monthly payments associated with the solution 155 and a total amount paid for solution 155.

As mentioned above, outcome identifier 170 may supplement received information where the information cannot be calculated. For example, in determining outcomes 230 associated with rolling credit card debt into mortgage debt, outcome identifier 170 may compare savings based on a solution 155 to paying off a credit card debt in x years, where x is the average amount of time that consumers pay off credit card debt (e.g., x=3 years). In such case, outcome identifier 170 may use the aggregate credit card balance (e.g., $10,000) and a calculated aggregate interest rate (18%), combined with a 36-month expected payoff period (x=3 years) to calculate the monthly payment and lifetime payments associated with a credit card debt. The same credit card balance (e.g., $10,000) may then be used by outcome identifier 170 to determine outcomes 230 based on solutions 155. Thus, outcome identifier may 170 may then calculate monthly payments and lifetime savings associated with a first solution 155, and ultimately calculate monthly and lifetime savings for user 120. In some embodiments, if outcome identifier 170 supplemented a variable (e.g., number of payoff years), recommendation engine 170 will not display an associated savings amount (e.g., lifetime savings amount).

As another example, in determining outcomes 230 associated with transferring credit card debt to another credit card debt, outcome identifier 170 may supplement payoff term in calculating total payoff under an existing credit card debt of user 120 and in calculating total payoff under solution 155, wherein the solution 155 is a different credit card debt. Taking the above example, outcome identifier 170 may calculate monthly payments and total payoff amount associated with an existing credit card debt using the following variables: balance of existing credit card debt (e.g., $10,000), duration of payoff (e.g., supplemented as x=3 years), and the interest rate of the existing credit card debt (e.g., 18%). Outcome identifier may then calculate monthly payments and total payoff amount based on a solution 155. In doing so, outcome identifier may use the same supplemented duration of payoff (x=3 years). Outcome identifier 170 may then compute monthly savings and/or lifetime savings (comparatively) based on the calculated monthly and payoff amounts.

Outcome identifier 170 may also be configured to determine outcomes 230 when terms of the solution 155 change over time. As one example, outcome identifier 170 may be able to compute savings to user 120 for credit cards offering introductory interest rates. For example, if solution 155 offers a credit card with a 0% APR for 12 months and a 15% APR thereafter, outcome identifier 170 may account for such changes and calculate savings to user 120 accordingly. In some embodiments, outcome identifier 170 may calculate payoff amounts by summing the calculated monthly payments for one year based on 0% APR and calculated monthly payments for two years based on 15% APR. In other embodiments, outcome identifier 170 may calculate payoff amount based on an average interest rate (e.g., 8%) over the supplemented three year term. Outcome identifier 170 may then use these calculated payment amounts based on solution 155, along with the calculated payment amounts based on existing credit card debt to determine an amount of savings to user 120.

After determining one or more outcomes 230, recommendation engine 150 may recommend one or more solutions 155* of the plurality of solutions 155 to user 120. In some embodiments, solution selector 180 of recommendation engine 150 recommends solution(s) 155* to user 120. For example, in some embodiments, solution selector selects solution 155* of the plurality of solutions 155 and displays information about selected solution 155* to user 120. Solution selector 180 may select solution 155* based on the outcome for selected solution 155*. For example, solution selector 180 may select solution 155a because outcome 230a was most favorable to user 120. In some embodiments, solution selector 180 only recommends solutions 155 that are associated with a cost savings to user 120 (e.g., lifetime savings and/or monthly savings).

In operation, recommendation engine may generate one or more solutions to a particular client issue or problem. Taking the above example of user 120a (client seeking a solution to optimize debt), collection engine 160 may receive situational information about user 120b. This situational information 210 may include information about the current financial situation of user 120b including all debts (e.g., mortgages, credit card balances, automobile loans, personal loans and/or student loans) and other personal financial information (e.g., credit score and credit history). Collection engine 160 may also receive information about a plurality of solutions 155. In this particular example, the plurality of solutions 155 may comprise a plurality of lender offers, credit card offers, debt settlement offers, and the information about the plurality of solutions 155 may include identity of entity offering the solution (e.g., identity of lender, credit card company, negotiating company), interest rate associated with the solution, annual percentage rate (APR) associated with the solution, and/or costs associated with the solution (e.g., annual fees, transfer fees settlement fees). Outcome identifier 170 may use the received information to determine an outcome 230 for each solution of the plurality of solutions 155 (or alternatively, for a bundle of solutions 155). For example, outcome identifier 170 may determine a monthly savings amount for user 120b based on the received situational information and information about a first loan offer. As another example, outcome identifier 170 may determine a monthly savings amount for user 120b based on the received situational information and information about a second loan offer. In other embodiments, the outcome 230 determined by outcome identifier 230 may be a lifetime savings amount for the client, a monthly savings amount for the client, an adjustment of loan term, or any other feature that may make a particular solution attractive to user 120b. In some embodiments, outcome 230 may be a ranking of the loan offer relative to another loan offer. For example, outcomes 230 may be ranked relative to one another using a formula that accounts for savings to client, costs, break even months, ratings of the lender, and any other terms of the lender (e.g., loan forgiveness terms and/or deferment terms).

In some embodiments, outcome identifier 170 filters the plurality of solutions 155 based on rules before outcome identifier 170 determines outcomes 230. Such rules may be stored internally or externally and may be added to or edited. Rules implemented by outcome identifier 170 may be to filter solutions 155 based on (1) the debt or type of debt user 120 wishes to optimize; and (2) whether user 120 has a mortgage. Implementing such a rule may yield various recommendations depending on the particular debt or type of debt that user 120 wishes to optimize. For example, if user 120 wishes to optimize mortgage debt, outcome identifier 170 may determine outcomes 230 based solely on solutions 155 related to mortgage offers. As another example, if user 120 wishes to optimize credit card debt, outcome identifier 170 may determine outcomes 230 based on solutions 155 related to mortgage offers (if user 120 has an existing mortgage), solutions 155 related to credit card offers, and solutions 155 related to personal loan offers. As yet another example, if user 120 wishes to optimize personal loan debt, outcome identifier 170 may determine outcomes 230 based on solutions 155 related to mortgage offers (if user 120 has an existing mortgage) and solutions 155 related to personal loan offers.

After determining one or more outcomes 230, recommendation engine 150 may recommend one or more solutions 155* of the plurality of solutions 155. Recommending a solution 155* may be carried out by solution selector 180. In some embodiments, solution selector 180 selects one or more solutions 155* of the plurality of solutions 155 and displays information about the one or more selected solutions 155* to user 120a. For example, solution selector 180 may select solution 155a because outcome 230a revealed that solution 155a was ranked first among all other solutions 155. After selecting solution 155a, solution selector 180 may display information about selected solution 155a to user 120a. The information displayed by solution selector 180 may be any information about selected solution 155a (e.g., identification of service provider, cost savings with solution, break even months, adjusted payment amount, and/or costs associated with the solution).

In some embodiments, when determining which solution or solutions to recommend, recommendation engine 150 determines which solutions are most applicable to user 120 based on criteria that vary based on debt type. For example, if user 120 seeks to optimize mortgage debt, solution selector 180 may only select solutions 155 that match certain terms of user 120's existing mortgage (e.g., if user 120's existing mortgage is a 30-year term, solution selector 180 will only choose solutions 155 offering a 30-year term; if user 120's existing mortgage is a 5-year ARM, solution selector 180 will only select solutions 155 offering a 5-year ARM; if the location of user 120's mortgage is California, solution selector 180 will only select solutions 155 that are offered in California). As another example, solution selector 180 may be configured to only select solutions 155 for which user 120 is eligible (e.g., solution selector 180 will not select a solution 155 that requires excellent credit (score of 750+) when user 120 has fair credit (score between 650-699). As yet another example, if user 120 seeks to optimize personal loan debt, solution selector 180 may only select solutions 155 that are offered in the same state as her existing personal loan debt.

Recommendation engine 150 may be configured to prioritize one solution 155 over another solution 155 based on priority rules in some embodiments. For example, recommendation engine 150 may be configured to prioritize matching like-terms related to the debt (e.g., debt term, state where debt exists, adjustable/fixed rate) over a credit score range, and prioritizing credit score range over the location of the debt. For example, user 120 may have a 30-year fixed mortgage, a credit score of 650, and the mortgage is located in Florida. Recommendation engine 150 may first search for a perfect match for user 120: one or more solutions 155 offering a 30-year fixed mortgage in Florida to a person having a credit score of 650. If recommendation engine 150 is unable to find such solution 155, recommendation engine 150 may search for, and select, one or more non-state matched, 30-year fixed mortgage solutions 155 offered to a person having a credit score of 650. If recommendation engine 150 is unable to find such a solution, recommendation engine 150 may then search for, and select, one or more non-credit score matched, 30-year fixed mortgage solutions 155 offered in Florida. If recommendation engine 150 is unable to find a solution meeting those criteria, recommendation engine 150 may then search for, and select, one or more non-credit score matched and non-state matched, 30-year fixed mortgage solutions 155. If recommendation engine 150 is unable to find a solution meeting those criteria, recommendation engine 150 may search for, and select, any non-disqualified mortgage solutions 155.

In some embodiments, the information displayed by solution selector 180 may also comprise a suggestion that user 120 should take based on the selected solution and the situational data. For example, solution selector 180 may display a suggestion such as one of the following: refinance, acquire new debt and transfer the existing debt into the new debt, payoff existing debt, or negotiate debt down. Alternatively, recommendation engine 150 may determine that the debt is optimized and solution selector 180 does not display one of the above listed suggestions.

In determining which, if any, suggestion to display, recommendation engine 150 may be follow a set of preconfigured rules. For example, in determining a solution for optimizing mortgage debt, recommendation engine may be configured to make one of the following suggestions: (1) negotiate debt down; (2) shift debt into mortgage. Notably, one or more suggestions may not be available, based on the preconfigured rules, for a particular type of debt. For example, the suggestion to pay off existing debt may not be available for mortgage debt but may be available for other types of debt such as personal loans, credit card debt, student loan debt and/or automobile loan debt. As another example, the suggestion to acquire more debt to pay off existing debt may not be available for certain types of debt (e.g., automobile-related debt and student-related debt). As yet another example, the suggestion to trade out debt for other debt may not be available for certain types of debt (e.g., automobile-related debt and student-debt) because the other types of debt (e.g., credit card, personal loan, mortgage) may be associated with higher interest rates.

Turning now to FIG. 3, method 300 illustrates one embodiment of a method of generating solutions using recommendation engine 150. The method 300 begins at step 305 and continues to step 310. At step 310, recommendation engine 150 receives a request from user 120 over the Internet. In some embodiments, user 120 sends the request via device 125. The request from client may be related to a particular problem or issue that user 120 seeks resolution for. Taking the above example of user 120a, the client may seek to optimize his/her debts. In such an example, the request may comprise an identification of debt(s) associated with user 120a. For example, in some embodiments, client may request optimization solutions for his/her credit card debt and mortgage debt. In some embodiments, the method 300 continues to step 320.

At step 320, recommendation engine 150 formulates a query using the information in the request. In some embodiments, the query is formulated automatically and is electronic. For example, recommendation engine 150 may automatically formulate an electronic query using the identified debts associated with user 120a (e.g., credit card debt and mortgage debt). In some embodiments, the method 300 continues to step 330.

At step 330, recommendation engine 150 sends the query over the Internet to situational information provider(s) 130. In some embodiments, recommendation engine 150 sends the query to one situational information provider 130. In other embodiments, recommendation engine 150 sends the query to more than one situational information provider 130. In some embodiments, the situational information provider 130 is not user 120. In other embodiments, user 120 is one of situational information providers 130. In some embodiments, the method 300 continues to step 340.

At step 340, recommendation engine 150 receive first information over the Internet. In some embodiments, the first information is received from situational information provider(s) 130. In some embodiments, the first information is situational information 210. Taking the above example of user 120a, the first information may comprise debt data associated with the identified debts associated with the client. For example, debt data may include information about the current balance of user 120a's mortgage or credit cards, APRs associated with user 120a's credit cards, interest rates associated with user 120a's mortgage, minimum monthly/annual payments associated with user 120a's mortgage/credit card, term of mortgage, mortgage type (e.g., fixed or variable), state/country where mortgage was opened. In some embodiments, the method 300 continues to step 350.

At step 350, recommendation engine 150 receives second information over the Internet. In some embodiments, the second information is received from at service provider(s) 140. In some embodiments, the second information comprises a plurality of offerings (also referred to herein as solutions 155). In the above example of user 120a, the second information may comprise a plurality of offerings associated with the identified debts associated with user 120a. In some embodiments, user 120 is not a service provider 140. In some embodiments, the situational information provider(s) 130 is/are not service provider(s) 140. In some embodiments, the method 300 continues to step 360.

At step 360, recommendation engine 150 determines an outcome 230 for each offering of the plurality of offerings 155 based on the first information (e.g., situational information 210) and the second information (e.g., plurality of offerings 155). In reference to user 120a, recommendation engine 150 may determine an annual savings amount for each offering offered by service provider(s) 130. For example, recommendation engine 150 may determine an annual savings amount (e.g., outcome 230) for user 120a if user 120a refinanced his/her existing mortgage according to the terms of a first loan offer offered by a first lender. As another example, recommendation engine 150 may determine an annual savings amount (e.g., outcome 230) for user 120a if user 120a took out a home equity loan, according to terms of a second loan offer offered by the first lender, to pay off existing credit card debt. Although specific types of outcomes have been described, recommendation engine 150 may determine any suitable outcome 230 for each offering of the plurality of offerings. In some embodiments, the method 300 may continue to step 370.

At step 370, recommendation engine 150 selects a first offering (e.g., solution 155* of FIGS. 1 and 2) of the plurality of offerings (e.g., 155). In some embodiments, selecting the first offering is based on comparing the determined outcomes. For instance, taking the above examples of outcomes, recommendation engine 150 may choose the second loan offer because it is associated with a greater annual savings than the first loan offer. Alternatively, recommendation engine 150 may choose the first loan offer because it is associated with a greater lifetime savings than the second loan offer. Although specific reasons of selecting one offering over another offering have been described, this disclosure recognizes selecting a first offering of the plurality of offerings for any suitable reason. In some embodiments, a suitable reason is a reason that provides benefits to user 120. In some embodiments, the method 300 continues to step 380.

At step 380, recommendation engine 150 displays information about the selected solution (e.g., 155*) to user 120. In some embodiments, the information displayed may be any information about selected solution 155*. For example, the information displayed may be one or more of: identity of service provider 140, cost of solution, a savings associated with the selected solution, and/or a rate corresponding to the selected solution. In some embodiments, the information displayed may also comprise a suggestion that the client should take based on the selected solution and the information associated with the client. For example, recommendation engine 150 may display a suggestion such as “refinance,” “acquire new debt and transfer existing debt into the new debt,” “payoff existing debt,” and/or “negotiate debt down,” for user 120a seeking a debt optimization solution. As a specific example, recommendation engine 150 may display the following suggestion to user 120a: “REFINANCE MORTGAGE WITH SERVICE PROVIDER A TO SAVE $394/MO.” Taking the above example of user 120b (seeking a storage solution), recommendation engine 150 may display the following suggestion: “WAIT TO BUY. COST EXPECTED TO DROP WITHIN 24 HOURS.” As another example, recommendation engine may display: “BUY NOW—COST AT AN ALL TIME LOW” to user 120b. Although specific examples of suggestions have been described, this disclosure recognizes displaying any suitable suggestion based on selected solution 155* and situational information 210. In some embodiments, the method 300 continues to an end step 385.

FIGS. 4-6 illustrate examples of interfaces displaying solutions generated by recommendation engine 150. Turning first to FIG. 4, interface 400 shows information received by recommendation engine 150 and solutions generated by recommendation engine 150 based on the received information. Interface 400 displays received information such as situational information 210 about user 120. In some embodiments, the received information displayed in interface 400 is the information received by recommendation engine 150 from situational information provider(s) 130 at step 340 of method 300. For example, as depicted in interface 400, the displayed situational information includes the credit score 405 of user 120, information about one or more credit cards 410 of user 120, information about one or more mortgages 420 of user 120, information about one or more automobile loans 430 of user 120, information about one or more student loans 440 of user 120, and information about one or more personal loans of user 120.

As depicted, interface 400 displays information about user 120's credit score 405, user 120's credit cards 410a-c and information about user 120's mortgage 420 and loans 430, 440, 450. According to interface 400, user 120 has an “excellent” credit score 405 of 777, has a first credit card with Credit Card Company #1 with a $5,000 credit limit and a 12% APR (see 410a), has a second credit card with Credit Card Company #2 with a $5,000 credit limit and a 12% APR (see 410b), and has a third credit card with Credit Card Company #3 with a $5,000 credit limit and a 12% APR (see 410c). Additionally, according to interface 400, user 120 has a home valued at $550,000, is carrying a $250,000 balance on his mortgage, has a 3.5% interest rate on his mortgage, and has a monthly mortgage payment of $1,730 (see 420). Information regarding the balance, interest rate, and payment amounts of user 120's loans is also displayed (see 430, 440, and 450). In addition to showing breakdowns of user 120's debt (e.g., 410, 420, 430, 440, and 450), interface 400 also displays information representing user 120's overall financial situation 460. According to interface 400, user 120 has $200,000 of total debt with an average interest rate of 12%, which is associated with a cost of $24,000/year. It will be appreciated that in addition to receiving information associated with the client (situational information 210), recommendation engine 150 receives information about the plurality of solutions 155 (not depicted). By receiving situational information 210 and information about the plurality of offers 155, recommendation engine 150 may determine outcomes 230 for each of the plurality of solutions 155, select one or more solutions 155* of the plurality of solutions 155 based on outcomes 230, and display information about the one or more selected solutions 155*to user 120.

Interface 400 also displays information about selected solutions generated by recommendation engine 150. In some embodiments, the information displayed about selected solutions in interface 400 may be the information displayed by recommendation engine 150 at step 380 of method 300. For example, interface 400 displays information about two selected solutions, identified as “Loan offer 1” and “Loan offer 2,” which could save user 120 $7,500 and $7,000 respectively (see 470). Interface 400 identifies that these solutions are based, in part, on trading out debt from Credit Card #1 and acquiring a home equity loan with an interest rate of 4-6%. Similarly, interface 400 shows two solutions identified as either “Loan offer 1” or “Card offer #1” and either “Loan offer 2” or “Card offer #2,” which could save user 120 $7,500 and $7,000 respectively (see 475, 480, and 485) by: trading credit card debt from Credit Card #1 to a personal loan with an interest rate of 6-8% (475), trading credit card debt from Credit Card #1 to a low interest credit cards (480), or trading credit card debt from Credit Card #1 to a balance transfer credit card (485). All these selected solutions 155* may be generated by recommendation engine 150 by receiving information associated with the client 210 and information associated with a plurality of solutions 155.

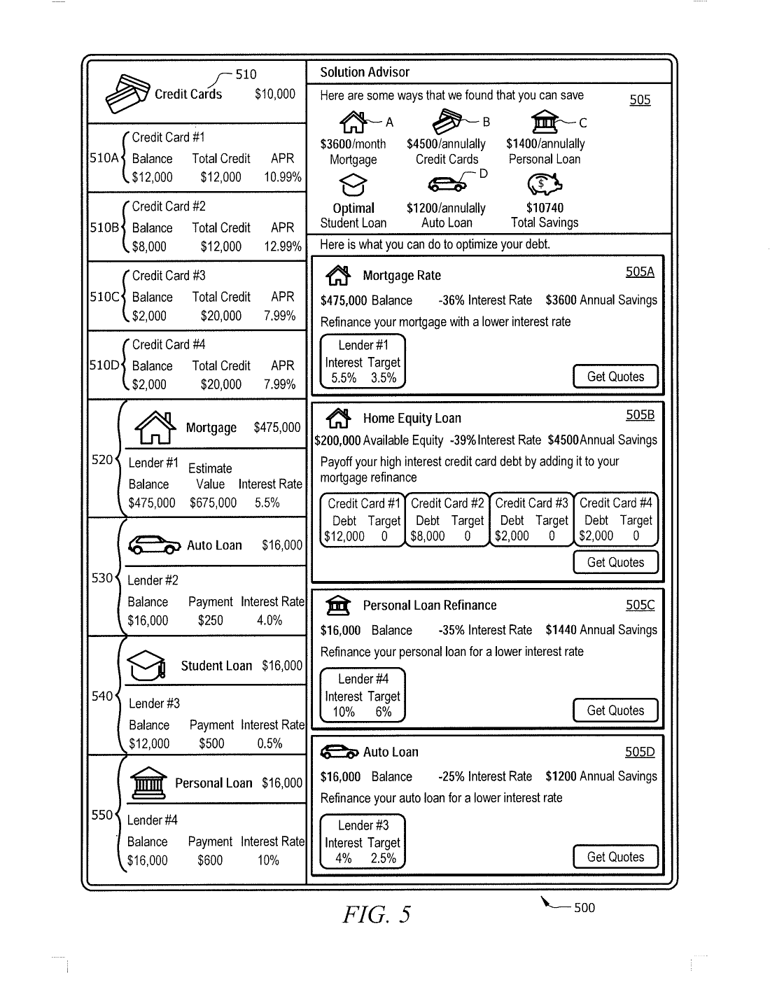

Interface 500 of FIG. 5 also displays received information such as the information associated with user 120. In some embodiments, the received information displayed in interface 500 may be the information received by recommendation engine 150 from situational information provider(s) 130 at step 340 of method 300. As depicted, interface 500 shows the information associated with client 210 includes information about credit cards 510a-d, information about a mortgage 520 of user 120, information about an automobile loan 530 of user 120, information about a student loan 540 of user 120, and information about a personal loan 550 of user 120. Interface 500 also displays information about solutions that optimize the existing debts of user 120 (see 505a-d). In some embodiments, the information displayed about solutions in interface 500 is the information displayed by recommendation engine 150 at step 380 of method 300. For example, interface 500 displays a first debt optimization solution 505a displaying information about optimizing user 120's mortgage debt. As depicted, interface 500 shows user 120 could save $3,600 annually if user 120 refinanced his $475,000 mortgage balance at a 3.5% interest rate, a 2-point reduction from his current 5.5% rate. Accordingly, the information about the selected solution displayed by recommendation engine 150 includes the calculated reduction in interest rate from 5.5% to 3.5%, the calculated annual savings ($3,600), the target interest rate (3.5%), and a suggestion to refinance.

Similarly, FIG. 5 illustrates that recommendation engine 150 displays information about selected solutions in other categories: solutions for optimizing user 120's credit card debt (505b), optimizing user 120's personal loan debt (505c), and optimizing user 120's automobile loan debt (505d). For example, the information about the selected solution displayed by recommendation engine 150 includes a suggestion to pay off the credit card debt by adding the debt to a mortgage refinance, a calculated reduction in interest rate by paying off credit card debt as suggested, and annual savings by paying off the credit card debt as suggested ($4,500) (see 405b). Recommendation engine 150 may perform the steps of method 300 to generate solutions, and information about solutions, for each identified client issue (e.g., optimizing client personal loan debt 505c, optimizing client automobile debt 505d).

Finally, interface 600 of FIG. 6 displays different solutions (A-C) for optimizing mortgage-related debt. Recommendation engine 150 may perform the steps of method 300 to generate solution A. As depicted, recommendation engine 150 may generate a recommendation (Solution A) based on received information, including information associated with the client 610 (lender of existing mortgage 610a, balance of existing mortgage 610b, interest rate of existing mortgage 610c, loan term of existing mortgage 610d, payment of existing mortgage 610e, type of loan 610f, and state of existing mortgage 610g) and information associated with a plurality of solutions (not depicted). In some embodiments, the received information displayed in interface 600 is the information received by recommendation engine 150 from situational information providers 130 at step 340 of method 300. After receiving the information, recommendation engine may determine an output for each of the plurality of solutions, select one, Solution A, of the plurality of solutions, and display information about Solution A to user 120. As depicted, the information about Solution A includes a suggestion to refinance user 120's existing mortgage (see 620). Recommendation engine 150 also displays information about Solution A including the payment amount corresponding to the selected solution 620a, a number of break-even months 620b, costs associated with the selected solution 620c, and savings corresponding to the selected solution 620d.

As depicted, Solution B includes a suggestion to shift existing credit card debt into mortgage debt and the Solution C includes a suggestion to shift existing personal loan debt into mortgage debt. Recommendation engine 150 may also perform steps of method 300 to generate Solutions B and C. For example, recommendation engine 150 may generate a recommendation (Solutions B, C) based on received information associated with the client (e.g., 630a-d and 650a-d) and information associated with a plurality of solutions (not depicted). Additionally, recommendation engine 150 may determine an output (e.g., savings 640d, 660d) for each solution of the plurality of solutions based on the received information, and select Solution B and C, respectively. Further, recommendation engine 150 may display information about Solution B (640a-d) and Solution D (660a-d) to user 120. In some embodiments, the information displayed about selected solutions A, B, and C of interface 600 is information displayed by recommendation engine 150 at step 380 of method 300.

This disclosure has described various algorithms for recommending solutions using a recommendation engine 150. For example, this disclosure describes algorithms for determining which financial offers are relevant to a user 120 and algorithms for calculating savings differentials for a user 120 based on various available offers. In addition to these algorithms, recommendation engine 150 may be associated with other algorithms such as those that determine and/or present user 120 with relevant content and algorithms which determine and/or present advertisements most relevant to user 120. In some embodiments, recommendation engine 150 may be configured to store these algorithms. The algorithms may be stored internally or externally. In some embodiments, the algorithms may be stored in storage 730 of computer 700 as depicted in FIG. 7.

FIG. 7 illustrates an example of a computer system 700. As described above, recommendation engine 150 may be a program that is implemented by a processor of a computer system such as computer system 700. Computer system 700 may be any suitable computing system in any suitable physical form. In some embodiments, computer system 700 may be client device 125. As example and not by way of limitation, computer system 700 may be a virtual machine (VM), an embedded computer system, a system-on-chip (SOC), a single-board computer system (SBC) (e.g., a computer-on-module (COM) or system-on-module (SOM)), a desktop computer system, a laptop or notebook computer system, a mainframe, a mesh of computer systems, a server, an application server, or a combination of two or more of these. Where appropriate, computer system 700 may include one or more computer systems 700; be unitary or distributed; span multiple locations; span multiple machines; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

One or more computer systems 700 may perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As an example and not by way of limitation, computer system 700 may be an embedded computer system, a system-on-chip (SOC), a single-board computer system (SBC) (such as, for example, a computer-on-module (COM) or system-on-module (SUM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

Computer system 700 may include a processor 710, memory 720, storage 730, an input/output (I/O) interface 740, a communication interface 750, and a bus 770 in some embodiments, such as depicted in FIG. 7. Although this disclosure describes and illustrates a particular computer system having a particular number of particular components in a particular arrangement, this disclosure contemplates any suitable computer system having any suitable number of any suitable components in any suitable arrangement.

Processor 710 includes hardware for executing instructions, such as those making up a computer program, in particular embodiments. For example, processor 710 may execute recommendation engine 150 to generate solutions. As an example and not by way of limitation, to execute instructions, processor 710 may retrieve (or fetch) the instructions from an internal register, an internal cache, memory 720, or storage 730; decode and execute them; and then write one or more results to an internal register, an internal cache, memory 720, or storage 730. In particular embodiments, processor 710 may include one or more internal caches for data, instructions, or addresses. This disclosure contemplates processor 710 including any suitable number of any suitable internal caches, where appropriate. As an example and not by way of limitation, processor 710 may include one or more instruction caches, one or more data caches, and one or more translation lookaside buffers (TLBs). Instructions in the instruction caches may be copies of instructions in memory 720 or storage 730, and the instruction caches may speed up retrieval of those instructions by processor 710. Data in the data caches may be copies of data in memory 720 or storage 730 for instructions executing at processor 710 to operate on; the results of previous instructions executed at processor 710 for access by subsequent instructions executing at processor 710 or for writing to memory 720 or storage 730; or other suitable data. The data caches may speed up read or write operations by processor 710. The TLBs may speed up virtual-address translation for processor 710. In particular embodiments, processor 710 may include one or more internal registers for data, instructions, or addresses. This disclosure contemplates processor 710 including any suitable number of any suitable internal registers, where appropriate. Where appropriate, processor 710 may include one or more arithmetic logic units (ALUs); be a multi-core processor; or include one or more processors 175. Although this disclosure describes and illustrates a particular processor, this disclosure contemplates any suitable processor.

Memory 720 may include main memory for storing instructions for processor 710 to execute or data for processor 710 to operate on. As an example and not by way of limitation, computer system 700 may load instructions from storage 730 or another source (such as, for example, another computer system 700) to memory 720. Processor 710 may then load the instructions from memory 720 to an internal register or internal cache. To execute the instructions, processor 710 may retrieve the instructions from the internal register or internal cache and decode them. During or after execution of the instructions, processor 710 may write one or more results (which may be intermediate or final results) to the internal register or internal cache. Processor 710 may then write one or more of those results to memory 720. In particular embodiments, processor 710 executes only instructions in one or more internal registers or internal caches or in memory 720 (as opposed to storage 730 or elsewhere) and operates only on data in one or more internal registers or internal caches or in memory 720 (as opposed to storage 730 or elsewhere). One or more memory buses (which may each include an address bus and a data bus) may couple processor 710 to memory 720. Bus 770 may include one or more memory buses, as described below. In particular embodiments, one or more memory management units (MMUs) reside between processor 710 and memory 720 and facilitate accesses to memory 720 requested by processor 710. In particular embodiments, memory 720 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 720 may include one or more memories 180, where appropriate. Although this disclosure describes and illustrates particular memory, this disclosure contemplates any suitable memory.

Storage 730 may include mass storage for data or instructions. As an example and not by way of limitation, storage 730 may include a hard disk drive (HDD), a floppy disk drive, flash memory, an optical disc, a magneto-optical disc, magnetic tape, or a Universal Serial Bus (USB) drive or a combination of two or more of these. Storage 730 may include removable or non-removable (or fixed) media, where appropriate. Storage 730 may be internal or external to computer system 700, where appropriate. In particular embodiments, storage 730 is non-volatile, solid-state memory. In particular embodiments, storage 730 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 730 taking any suitable physical form. Storage 730 may include one or more storage control units facilitating communication between processor 710 and storage 730, where appropriate. Where appropriate, storage 730 may include one or more storages 140. Although this disclosure describes and illustrates particular storage, this disclosure contemplates any suitable storage.

I/O interface 740 may include hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 185 for them. Where appropriate, I/O interface 740 may include one or more device or software drivers enabling processor 710 to drive one or more of these I/O devices. I/O interface 740 may include one or more I/O interfaces 185, where appropriate. Although this disclosure describes and illustrates a particular I/O interface, this disclosure contemplates any suitable I/O interface.

Communication interface 750 may include hardware, software, or both providing one or more interfaces for communication (such as, for example, packet-based communication) between computer system 700 and one or more other computer systems 700 or one or more networks (e.g., network 110). As an example and not by way of limitation, communication interface 750 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 750 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 750 for any of these networks, where appropriate. Communication interface 750 may include one or more communication interfaces 190, where appropriate. Although this disclosure describes and illustrates a particular communication interface, this disclosure contemplates any suitable communication interface.

Bus 770 may include hardware, software, or both coupling components of computer system 700 to each other. As an example and not by way of limitation, bus 770 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 770 may include one or more buses 212, where appropriate. Although this disclosure describes and illustrates a particular bus, this disclosure contemplates any suitable bus or interconnect.

The components of computer system 700 may be integrated or separated. In some embodiments, components of computer system 700 may each be housed within a single chassis. The operations of computer system 700 may be performed by more, fewer, or other components. Additionally, operations of computer system 700 may be performed using any suitable logic that may comprise software, hardware, other logic, or any suitable combination of the preceding.

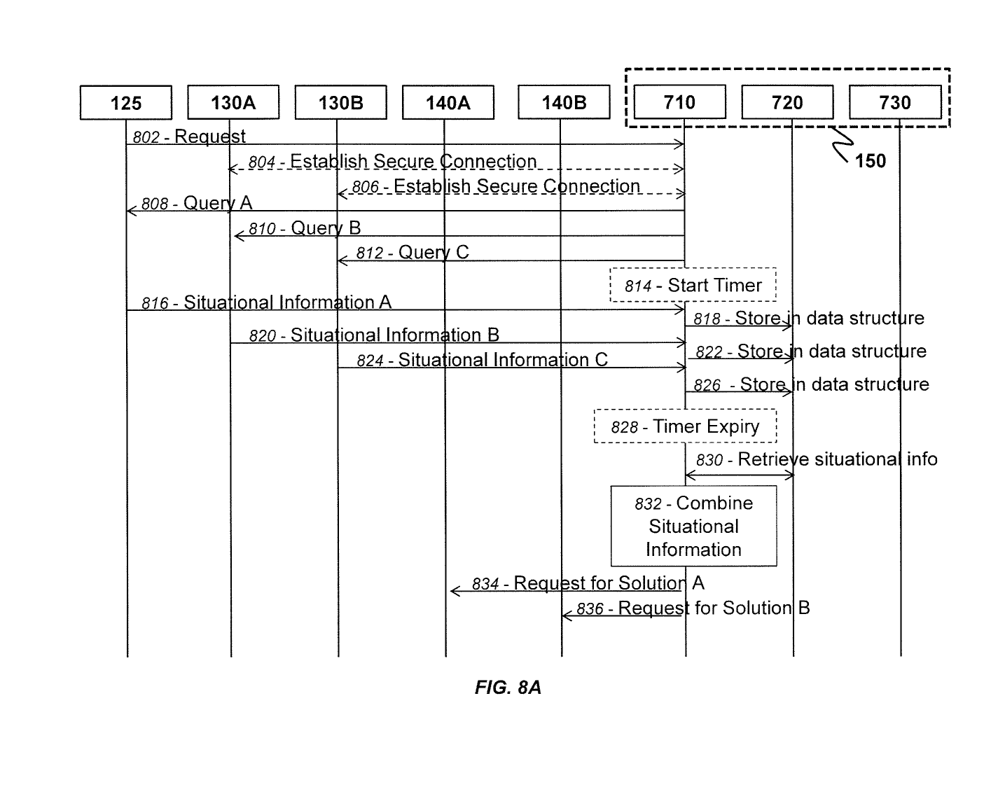

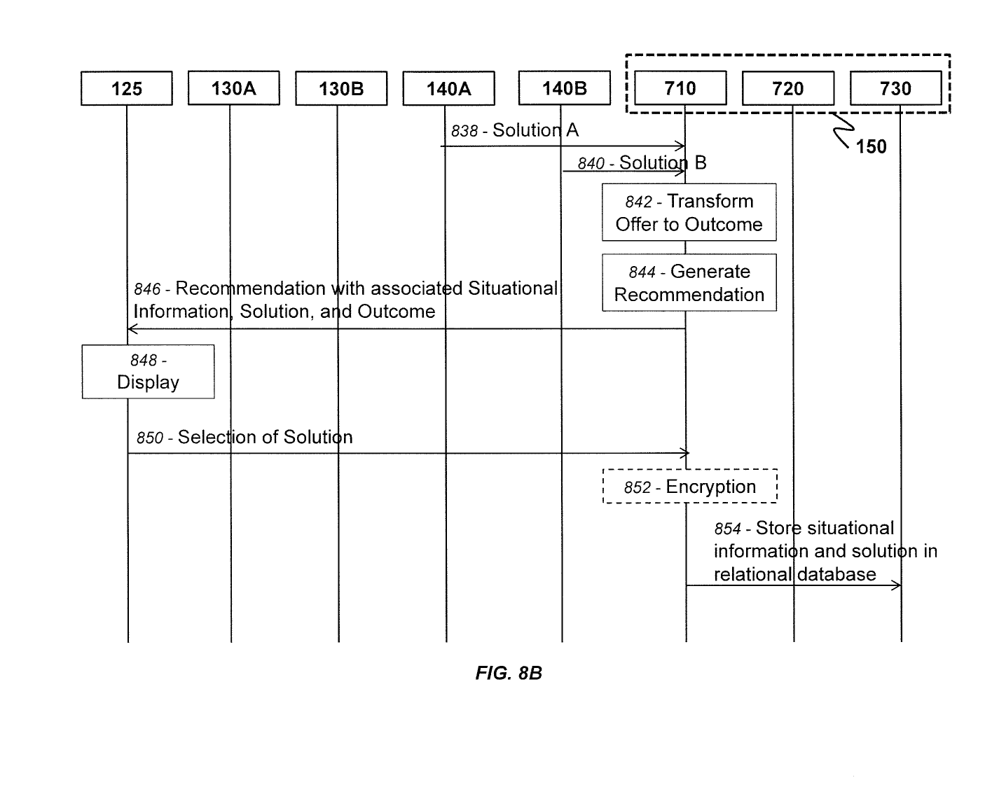

FIGS. 8A-8B provide a signal flow diagram illustrating communications between computing systems, such as recommendation engine 150 (which comprises processor 710, memory 720, and storage 730) and client device 125, situational information providers 130A and 130B, and service providers 140A and 140B, in accordance with certain embodiments. As discussed above, certain embodiments allow for simultaneous updating of situational information 210. Recommendation engine 150 may execute a number of parallel computing processes in order to facilitate simultaneous updating of situational information 210. Recommendation engine 150 may use a shared memory 720 to maintain situational information 210 from multiple processes. This may potentially cause collisions in which different processes respond to the same query with different results. Certain embodiments may provide solutions for such inter-process communications in order to avoid collisions that may otherwise cause recommendation engine 150 to store inaccurate information.

In step 802 of FIG. 8A, recommendation engine 150 receives a request 802 from client device 125. As an example, the request may indicate that a user 120 of client device has requested a recommendation about a debt. In response to receiving the request, recommendation engine 150 may initiate parallel computing processes to facilitate collecting situational information to be used in generating the requested recommendation. By using parallel computing processes, the speed and accuracy with which recommendation engine 150 generates the recommendation may be improved. For example, accuracy can be improved by collecting information from multiple sources (such as situational information provider 130A, situational information provider 130B, and/or client device 125) and using the subset of that information that recommendation engine 150 determines to have a better likelihood of being accurate.

To minimize delays associated with collecting information from multiple sources, recommendation engine 150 can collect the information from multiple sources in parallel. For example, recommendation engine 150 establishes a secure connection with a first situational information provider 130A at step 804 and with a second situational information provider 130B at step 806. Establishing a secure connection may comprise communicating credentials that authorize recommendation engine 150 to obtain situational information 210 associated with user 120 and/or establishing a connection using a secure protocol. Steps 804 and/or 806 may be optional in certain embodiments. For example, if situational information provider 130A provides publicly available information, it may not be necessary to establish a secure connection with situational information provider 130A. As another example, if situational information provider 130B provides private information about user 120, recommendation engine 150 can establish a secure connection to maintain privacy of the information.

Recommendation engine 150 may request situational information from any suitable number of situational information providers 130 and/or client device 125. For example, at step 808, recommendation engine 150 sends query A requesting situational information from client device 125. At step 810, recommendation engine 150 sends query B requesting situational information from situational information provider 130A. At step 812, recommendation engine sends query C requesting situational information from situational information provider 130B. Queries A, B, and C may request the same information, partially overlapping information, or different information. Queries A, B, and C may be sent in parallel computing processes such that recommendation engine 150 need not wait to receive a response to one query before sending the next query.

In certain embodiments, recommendation engine 150 may optionally start a timer at step 814. The timer may provide a maximum time that recommendation engine 150 is to wait for situational information. The value of the timer can be set according to a pre-defined value, or the timer value may be set dynamically (for example, based on the type of situational information requested in queries A, B, and C or based on the identities of the situational information providers 130 to which the queries were sent). The timer can be used to prevent the parallel computing processes from hanging in the event that recommendation engine 150 fails to receive a response to one or more of the queries. Thus, use of the timer may increase the speed with which recommendation engine 150 can provide a recommendation to user 120.

At step 816, recommendation engine 150 receives situational information A from client device 125. At step 818, recommendation engine 150 stores situational information A in a data structure. At step 820, recommendation engine 150 receives situational information B from situational information provider 130A. At step 822, recommendation engine 150 stores situational information B in the data structure. At step 824, recommendation engine 150 receives situational information C from situational information provider 130B. At step 822, recommendation engine 150 stores situational information C in the data structure. Situational information A, B, and C may be received by processor 710 of recommendation engine 150 and stored by memory 720 of recommendation engine 150. Situational information A, B, and C may be received and stored in any suitable order.

At step 828, recommendation engine 150 determines that the timer that was started in step 814 has expired. In response, if recommendation engine 150 determines that it lacks sufficient situational information, recommendation engine 150 may optionally initiate additional queries for situational information and may restart the timer while waiting for responses to the additional queries. Otherwise, if recommendation engine 150 determines that it has sufficient situational information when the timer expires, recommendation engine 150 may proceed to step 830 to retrieve the data from the data structure. Alternatively, in some embodiments, recommendation engine 150 could proceed to step 830 in response to determining that it has received sufficient situational information (without having to use a timer or wait for the timer to expire).

At step 832, recommendation engine 150 combines the situational information. For example, to the extent that situational information A, B, and C each provide different types of situational information, the situational information can be aggregated. If situational information A, B, and C each provide different results for the same type of situational information, recommendation engine 150 can use the result with the highest likelihood of being accurate. Recommendation engine 150 can use any suitable technique to determine which result has the highest likelihood of being accurate. For example, recommendation engine 150 can take into consideration the reliability of the source of the information, the recency of the information (e.g., newer information may be more up-to-date and therefore more accurate than older information), or other factors. Thus, the data structure may be used to handle collisions that occur when parallel computing processes attempt to store the same type of situational information to a shared memory location. Rather than overwriting situational information received from one source with situational information received from another source according to the order in which the situational information is received, the data structure can collect all of the situational information received from various sources over a period of time so that the data can be prioritized based on accuracy.

At step 834, recommendation engine 150 sends a request for a solution to a first service provider 140A, and at step 836, recommendation engine 150 sends a request for a solution to a second service provider 140B. In certain embodiments the requests sent in steps 834 and 836 can be tailored according to the request received in step 802 and/or the combined situational information generated in step 832.

Turning to FIG. 8B, at step 838, recommendation engine 150 receives solution A from service provider 140A, and at step 840 recommendation engine 150 receives solution B from service provider 140B. At step 842, recommendation engine transforms the solutions into outcomes 230. The outcomes 230 may be generated by outcome identifier 170, discussed above.

At step 844, recommendation engine 150 generates a recommendation based on comparing the outcomes 230. For example, recommendation engine 150 may compare the outcomes using solution selector 180, discussed above.

At step 846, recommendation engine 150 communicates the recommendation to client device 125. The recommendation may include situational information, solutions, and outcomes associated with the recommendation. As an example, the recommendation engine may communicate the top X number of solutions and corresponding outcomes. Limiting the messaging in step 846 to the top X number of solutions and corresponding outcomes may reduce network traffic/overhead and may allow the for communicating the recommendation more quickly and efficiently.

At step 848, client device 125 displays the information received in step 846 so that the user 120 can select a solution. In certain embodiments, client device 125 communicates user 120's selection to recommendation engine 150 at step 850. Recommendation engine 150 may then facilitate obtaining the solution (not shown in FIGS. 8A-8B). Alternatively, in certain embodiments, client device 125 may obtain the solution directly from the relevant service provider 140.

At step 852, recommendation engine 150 prepares the situational information and solution to be stored in storage 730. For example, recommendation engine 150 may optionally encrypt the data for added security. In certain embodiments, recommendation engine 150 stores the situational information and solution in a relational database (step 854). The relational database may associate the situational information (e.g., user's credit information) and the solutions with a user profile (e.g., a profile identifying the user and providing contact information). Relating the user profile, situational information, and solutions in a relational database may save processing time and processing resources for providing recommendations to subsequent requests from the user. For example, recommendation engine 150 can retrieve the information from the relational database as a starting point for a subsequent recommendation.

For simplicity, FIGS. 8A-8B have shown recommendation engine 150 as sending various messages to/from processor 710, memory 720, and storage 730. These components can communicate the messages via any suitable interface, such as I/O interface 740, communication interface 750, and/or bus 770.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the embodiments described or illustrated herein that a person having ordinary skill in the art would comprehend. The scope of this disclosure is not limited to the embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
at least one processor configured to:
receive a request from a client over the Internet, the request comprising an identification of at least two types of debt associated with the client;
automatically formulate an electronic query using the information in the request;
send the query over the Internet to at least a first situational information provider, the first situational information provider different than the client;
receive situational information over the Internet from the first situational information provider, the situational information comprising debt data associated with the at least two types of debt associated with the client;
receive a plurality of offerings over the Internet, the plurality of offerings associated with the at least two types of debt associated with the client, the plurality of offerings received from at least two service providers that are different than the client and the at least one situational information provider;
for each offering of the plurality of offerings, determine an outcome based on the first information and the second information;
select a first offering of the plurality of offerings as a selected solution, the first offering selected based on comparing the determined outcomes; and
communicate information about the selected solution to the client.

2. The system of claim 1, wherein the information about the selected solution communicated to the client comprises:
an identification of a lender corresponding to the selected solution;
a rate corresponding to the selected solution;
a payment amount corresponding to the selected solution; and
a costs amount corresponding to the selected solution.

3. The system of claim 1, the at least one processor further configured to compute an amount of savings corresponding to the selected solution and communicate the amount of savings to the client, the amount of savings computed per a periodic time period or per lifetime of the selected solution.

4. The system of claim 1, wherein the at least one processor is further configured to communicate a suggestion that the client should take based on the selected solution and the information associated with the client, the suggestion comprising one of:
refinance;
acquire new debt and transfer the existing debt into the new debt;
payoff existing debt; or
negotiate existing debt down.

5. The system of claim 1, the at least one processor is further configured to:
receive the situational information over the Internet from a second situational information provider, the situational information received from the second situational information provider while receiving the situational information from the first situational information provider; and
simultaneously update situational information stored in memory based on the situational information received from the first situational information provider and the situational information received from the second situational information provider.

6. The system of claim 1, the at least one processor further configured to:
calculate one or more variables to supplement the situational information, wherein the one or more variables are calculated in response to a determination that the situational information does not include sufficient information to determine the outcome of the plurality of offerings.

7. The system of claim 1, the at least one processor further configured to:
encrypt the received situational information; and
require the client to perform secure login to access the received situational information.

8. A non-transitory computer readable medium comprising logic, the logic, when executed by one or more processors, configured to:
receive a request from a client over the Internet, the request comprising an identification of at least two types of debt associated with the client;
automatically formulate an electronic query using the information in the request;
send the query over the Internet to at least a first situational information provider, the first situational information provider different than the client;
receive situational information over the Internet from the first situational information provider, the situational information comprising debt data associated with the at least two types of debt associated with the client;
receive a plurality of offerings over the Internet, the plurality of offerings associated with the at least two types of debt associated with the client, the plurality of offerings received from at least two service providers that are different than the client and the at least one situational information provider;
for each offering of the plurality of offerings, determine an outcome based on the first information and the second information;
select a first offering of the plurality of offerings as a selected solution, the first offering selected based on comparing the determined outcomes; and
communicate information about the selected solution to the client.

9. The computer readable medium of claim 8, wherein the information about the selected solution communicated to the client comprises:
an identification of a lender corresponding to the selected solution;
a rate corresponding to the selected solution;
a payment amount corresponding to the selected solution; and
a costs amount corresponding to the selected solution.

10. The computer readable medium of claim 8, the logic further configured to compute an amount of savings corresponding to the selected solution and communicate the amount of savings to the client, the amount of savings computed per a periodic time period or per lifetime of the selected solution.

11. The computer readable medium of claim 8, wherein the logic is further configured to communicate a suggestion that the client should take based on the selected solution and the information associated with the client, the suggestion comprising one of:
refinance;
acquire new debt and transfer the existing debt into the new debt;
payoff existing debt; or
negotiate existing debt down.

12. The computer readable medium of claim 8, further configured to:
receive the situational information over the Internet from a second situational information provider, the situational information received from the second situational information provider while receiving the situational information from the first situational information provider; and
simultaneously update situational information stored in memory based on the situational information received from the first situational information provider and the situational information received from the second situational information provider.

13. The computer readable medium of claim 8, the logic further configured to:
calculate one or more variables to supplement the situational information, wherein the one or more variables are calculated in response to a determination that the situational information does not include sufficient information to determine the outcome of the plurality of offerings.

14. The computer readable medium of claim 8, the at logic further configured to encrypt the received situational information and require the client to perform secure login to access the received situational information.

15. A method performed by one or more processors, the method comprising:
receiving a request from a client over the Internet, the request comprising an identification of at least two types of debt associated with the client;
automatically formulating an electronic query using the information in the request;
sending the query over the Internet to at least a first situational information provider, the first situational information provider different than the client;
receiving situational information over the Internet from the first situational information provider, the situational information comprising debt data associated with the at least two types of debt associated with the client;
receiving a plurality of offerings over the Internet, the plurality of offerings associated with the at least two types of debt associated with the client, the plurality of offerings received from at least two service providers that are different than the client and the at least one situational information provider;
for each offering of the plurality of offerings, determining an outcome based on the first information and the second information;
selecting a first offering of the plurality of offerings as a selected solution, the first offering selected based on comparing the determined outcomes; and
communicating information about the selected solution to the client.

16. The method of claim 15, wherein the information about the selected solution communicated to the client comprises:
an identification of a lender corresponding to the selected solution;
a rate corresponding to the selected solution;
a payment amount corresponding to the selected solution; and
a costs amount corresponding to the selected solution.

17. The method of claim 15, further comprising computing an amount of savings corresponding to the selected solution and communicating the amount of savings to the client, the amount of savings computed per a periodic time period or per lifetime of the selected solution.

18. The method of claim 15, further comprising communicating a suggestion that the client should take based on the selected solution and the information associated with the client, the suggestion comprising one of:
refinance;
acquire new debt and transfer the existing debt into the new debt;
payoff existing debt; or
negotiate existing debt down.

19. The method of claim 15, further comprising:
receiving the situational information over the Internet from a second situational information provider, the situational information received from the second situational information provider while receiving the situational information from the first situational information provider; and
simultaneously updating situational information stored in memory based on the situational information received from the first situational information provider and the situational information received from the second situational information provider.

20. The method of claim 15, further comprising:
calculating one or more variables to supplement the situational information, wherein the one or more variables are calculated in response to a determination that the situational information does not include sufficient information to determine the outcome of the plurality of offerings.
